(19) United States
(12) Patent Application Publication
(10) Pub. No.: US 2015/0081500 A1
(43) Pub. Date: Mar. 19, 2015

(54) INVESTMENT COMMUNICATION SYSTEM AND METHOD

(71) Applicant: YOUSTAK, INC., PALO ALTO, CA (US)

(72) Inventors: Michael James Dunne, Daisy Hill (AU); Robert Edmund Dunne, Daisy Hill (AU); Paul Francis Watts, Daisy Hill (AU)

(21) Appl. No.: 14/490,781

(22) Filed: Sep. 19, 2014

Related U.S. Application Data
(60) Provisional application No. 61/879,791, filed on Sep. 19, 2013.

(51) Int. Cl. G06Q 40/00; G06Q 30/02; H04L 29/08; G06F 3/0481; G06F 17/30

(52) U.S. Cl. CPC G06Q 40/00; G06F 3/0481; G06F 17/30595; H04L 67/10; G06Q 30/0282
USPC 705/35

(57) ABSTRACT

A method and system of investment communication enables efficient pairing of investors with potential investments. The method includes receiving, on a data interface, an investment request, wherein the investment request is associated with a first entity; receiving, on the data interface, a plurality of reviews associated with the first entity, wherein the plurality of reviews are each associated with a reviewer; determining, by a processor, an association between the reviewers and a first user; and providing, on the data interface and to the first user, the investment request and at least one review of the plurality of reviews, wherein the at least one review is selected according to the association between the reviewers and the first user.

### CROSS REFERENCE TO RELATED APPLICATIONS

The present application claims the benefit of Provisional Application No. 61/879,791, filed Sep. 19, 2013, which is herewith incorporated by reference into the present application.

### FIELD OF THE INVENTION

The present invention relates to data communication. In particular, although not exclusively, the invention relates to investment related communication.

### BACKGROUND

One important aspect relating to the success of a start-up company is the ability to receive investment, and in particular the ability to raise capital. Generally, substantial capital is required to realize growth in a start-up company, for example to enable further development or commercialization of a product or service.

Traditionally, start-up companies raise capital initially from friends and family, but more substantial capital investments are often made by private investors, such as angel investors and venture capitalists.

However, a problem with fund raising generally is that it is often difficult to provide a good match between potential investors and relevant start-ups. Furthermore, even when well matched investors and start-ups cross paths, it is often difficult for investors to quickly and efficiently evaluate the start-ups. Accordingly, investment opportunities are missed, which negatively impacts both investors and start-up companies.

In certain areas, angel investment groups exist that allow start-up companies to pitch directly to investors. While angel investment groups may help somewhat in matching start-ups and investors, they do not provide an efficient means for individual investors to find and evaluate start-up companies.

Accordingly, there is a need for an improved system and method for investment related communication.

### OBJECT OF THE INVENTION

It is an object of some embodiments of the present invention to provide improvements and advantages over the above described prior art, and/or overcome and alleviate one or more of the above described disadvantages of the prior art, and/or provide a useful commercial choice.

### SUMMARY

According to one aspect, the invention resides in a method of communication comprising:
receiving, on a data interface, an investment request, wherein the investment request is associated with a first entity;
receiving, on the data interface, a plurality of reviews associated with the first entity, wherein the plurality of reviews are each associated with a reviewer;
determining, by a processor, an association between the reviewers and a first user; and
providing, on the data interface and to the first user, the investment request and at least one review of the plurality of reviews, wherein the at least one review is selected according to the association between the reviewers and the first user.

Preferably, the first entity is a company. Suitably the investment request comprises a request for capital.

Preferably, each review in the plurality of reviews comprises a score. Alternatively or additionally, each review in the plurality of reviews comprises a textual element.

Preferably, providing the at least one review comprises providing a weighted score of a plurality of reviews.

Preferably, the weighted score is determined according to an association between the respective reviewers and the first user, and an age of the reviews.

Preferably, the method further comprises:
receiving, on the data interface, a preference from the first user;
wherein the weighted score is further determined according to the preference.

Preferably, the association comprises a relationship in a social network. More preferably, the association comprises a trust-based association. Suitably, the trust-based association comprises a level of trust.

Preferably, each review of the plurality of reviews includes a plurality of review components, wherein each review component is associated with a category.

Preferably, the categories include at least one of: a team category, a traction category, a market category, a monetization category, a competition category, a business model category, a company health category and a profile category.

Preferably, the method further comprises:
providing, on the data interface, a user customisable dashboard, the user customisable dashboard including the investment request and the at least one review.

Preferably, the method further comprises:
receiving, on the data interface, a plurality of investment requests, each of the investment requests associated with an entity; wherein the user customisable dashboard further includes at least one of the plurality of investment requests.

Preferably, the method further comprises:
receiving, on the data interface, at least one filter parameter associated with the first user;
wherein at least one request of the plurality of investment requests is selected according to the filter.

Preferably, the at least one filter parameter comprises at least one of a minimum rating, a minimum trusted rating, a minimum category rating, a location and a technology area.

According to another aspect, the invention resides in a communications system comprising:
a data interface;
a processor coupled to the data interface; and
a memory coupled to the processor, the memory including instruction code executable by the processor for:
   receiving, on the data interface, an investment request, wherein the investment request is associated with a first entity;
   receiving, on the data interface, a plurality of reviews associated with the first entity, wherein the plurality of reviews are each associated with a reviewer;
   determining an association between each of the reviewers and a first user; and
   providing, on the data interface and to the first user, the investment request and at least one review of the plurality of reviews, wherein the at least one review is selected according to the association between the reviewers and a first user.

According to a further aspect, the invention resides in a computer implemented investment system including:
a memory including:
   a plurality of user profiles, each of the plurality of user profiles associated with a user;
   a plurality of company profiles, each of the plurality of company profiles associated with a company;
   a plurality of investment requests, wherein each investment request is associated with a company; and
a plurality of reviews; wherein each review is associated with a user profile and a company profile;
a linking module, for providing an association between user profiles, and between user profiles and company profiles; and
a dashboard module, for providing investment requests and reviews to users, wherein the reviews are provided according to an association between a user profile and other user profiles to which the reviews are associated.

### BRIEF DESCRIPTION OF THE FIGURES

To assist in understanding the invention and to enable a person skilled in the art to put the invention into practical effect, preferred embodiments of the invention are described below by way of example only with reference to the accompanying drawings, in which:

FIG. 1 illustrates a system for investment based communication, according to an embodiment of the present invention;

FIG. 2 illustrates a screenshot of a personal dashboard page of the system of FIG. 1, according to an embodiment of the present invention;

FIG. 3 illustrates a screenshot of a manage capital page of the system of FIG. 1, according to an embodiment of the present invention;

FIG. 4 illustrates a further screenshot of the manage capital page, according to an embodiment of the present invention;

FIG. 5 illustrates a screenshot of a further personal dashboard page of the system of FIG. 1, according to an embodiment of the present invention;

FIG. 6 illustrates a screenshot of a manage request page of the system of FIG. 1, according to an embodiment of the present invention;

FIG. 7 illustrates a screenshot of a further manage request page of the system of FIG. 1, including investability review details, according to an embodiment of the present invention;

FIG. 8 illustrates a screenshot of a manage rating page of the system of FIG. 1, according to an embodiment of the present invention;

FIG. 9 illustrates a screenshot of a display rating page of the system of FIG. 1, according to an embodiment of the present invention;

FIG. 10 illustrates a screenshot of a rating analysis page of the system of FIG. 1, according to an embodiment of the present invention;

FIG. 11 illustrates a screenshot of an activate article page of the system of FIG. 1, according to an embodiment of the present invention;

FIG. 12 illustrates a method of communication, according to an embodiment of the present invention; and

FIG. 13 diagrammatically illustrates a computing device, according to an embodiment of the present invention.

Those skilled in the art will appreciate that minor deviations from the layout of components as illustrated in the drawings will not detract from the proper functioning of the disclosed embodiments of the present invention.

### DETAILED DESCRIPTION

Embodiments of the present invention comprise methods and systems for investment related communications. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, front and back, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The reference to any prior art in this specification is not, and should not be taken as, an acknowledgement or any form of suggestion that the prior art forms part of the common general knowledge.

According to one aspect, the invention resides in a method of communication comprising: receiving, on a data interface, an investment request, wherein the investment request is associated with a first entity; receiving, on the data interface, a plurality of reviews associated with the first entity, wherein the plurality of reviews are each associated with a reviewer; determining, by a processor, an association between the reviewers and a first user; and providing, on the data interface and to the first user, the investment request and at least one review of the plurality of reviews, wherein the at least one review is selected according to the association between the reviewers and the first user.

Advantages of certain embodiments of the present invention include an ability to efficiently pair investors and start-up companies, which can provide higher levels of investment and lower levels of risk associated with an investment.

Furthermore, certain embodiments of the present invention enable efficient transfer of knowledge between investors in a network, which facilitates efficient evaluation of investment proposals by the investors.

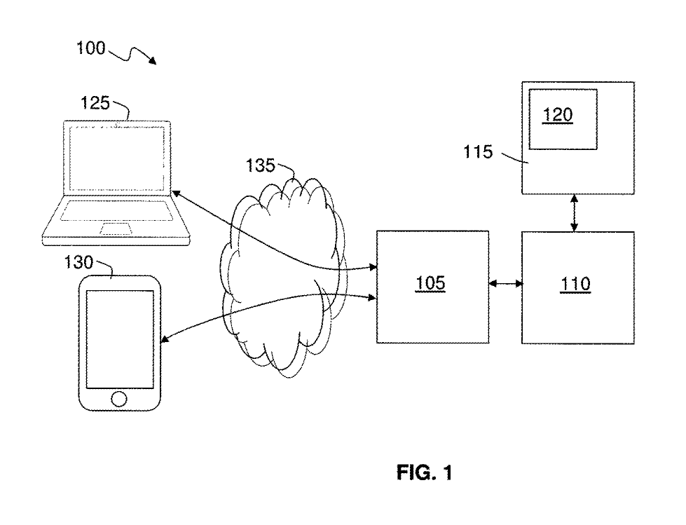

FIG. 1 illustrates a system 100 for investment based communication, according to an embodiment of the present invention.

The system 100 includes a data interface 105, a processor 110 coupled to the data interface 105 and a memory 115 coupled to the processor 110. The memory 115 includes computer readable instruction code 120 for generating dashboard pages, and providing investment based communication as discussed further below.

The system 100 further includes a first user device 125 and a second user device 130, the first and second user devices 125, 130 connected to the processor 110 via a data communications network 135 such as the internet.

The first and second user devices 125, 130 can be personal computers, smart phones, digital assistants, or any other suitable device. The first user device 125 can, for example, be a user device of a start-up company seeking expansion capital, and the second user device 130 can be a user device of a potential investor.

According to a first embodiment, the system 100 enables implementation of a social networking-like system. The social networking-like system includes a plurality of user profiles, each of the plurality of user profiles associated with a user, and a plurality of company profiles, each of the company profiles associated with a company. A first user of the first user device 125 can have a first user profile, and a second user of the second user device 130 can have a second user profile, and the first and second users can communicate with each other through their first and second user profiles, respectively.

The social networking-like system then can be used to connect users with companies, and particularly investors with start-up companies. As discussed in further detail below, a start-up company can create a company profile in the system 100 for the purpose of meeting relevant investors and raising capital. Filters then can be used to assist investors in finding relevant companies for investment.

The term company is used in a broad sense, and is not limited to any particular type of organisation, and can also include company proposals, such as where a company has not yet been formed.

Similarly, the term investment is used in a broad sense, and can, for example, include financial investment in the company, or intellectual investment, such as advice, or an evaluation of the company.

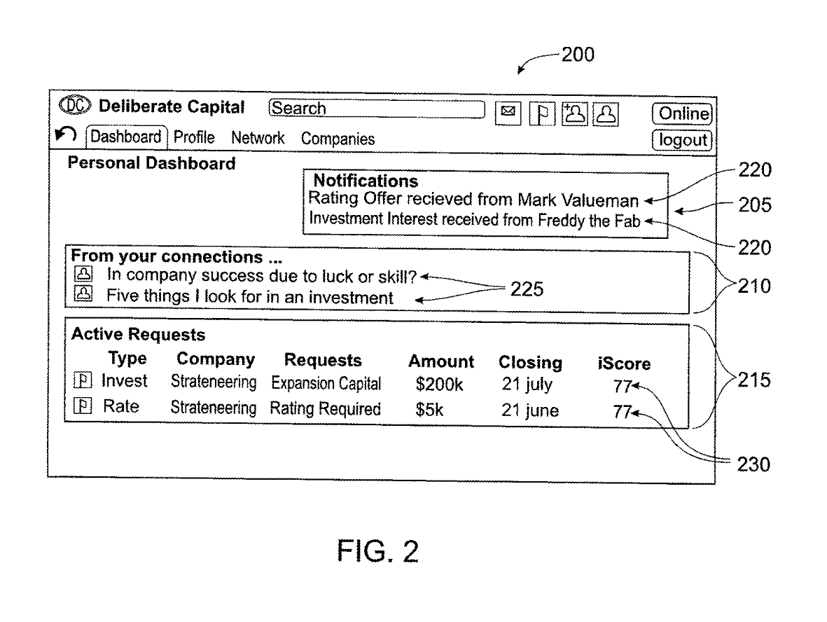

FIG. 2 illustrates a screenshot 200 of a personal dashboard page of the system 100, according to an embodiment of the present invention.

The personal dashboard page provides an overview of any investment requests that are associated with a user, as well as any external requests that match a filter of the user.

The personal dashboard page includes a notifications portion 205, for providing a summary of events associated with the user, a feed portion 210, for providing a social network-like feed from connections of the user, and an active requests portion 215, for providing details of active investment requests that are associated with the user.

The notifications portion 205 includes a plurality of event elements 220, each event element 220 providing a notification of an event such as a received rating offer or received interest in investment. Each event element 220 is selectable, and upon selection of an event element 220 further details of a corresponding event are provided.

The feed portion 210 includes a plurality of feed elements 225, each feed element 225 comprising a message and a source identifier in the form of an image, wherein the source identifier identifies a source of the message. Examples of messages can include recent events and/or other relevant information relating to the user, “posts” of a social networking system, or posts specific to the system 100, such as informational articles posted to the system 100. Examples of relevant social networking systems include LinkedIn of LinkedIn Corporation of Mountain View, Calif., United States.

Each feed element 225 is selectable, and upon selection of a feed element 225 details of the source of the message (e.g. a user) and/or the message are provided. The active requests portion 215 includes a plurality of investment request elements 230, each of the investment request elements 230 associated with a request for investment. As discussed further below, a user can select one or more filter criteria for filtering investment requests from other users. In such case, investment requests that fulfill the filter criteria are presented to the user in the form of investment request elements 230 and are able to be selected by the user for categorisation in the active requests portion 215.

The investment request elements 230 can, for example, include requests for investment in the form of a request for capital, such as investment capital, or requests to evaluate the firm and provide a rating (discussed further below), thus an intellectual investment.

Upon selection of a request for capital element 230, a manage capital page (discussed below) is provided.

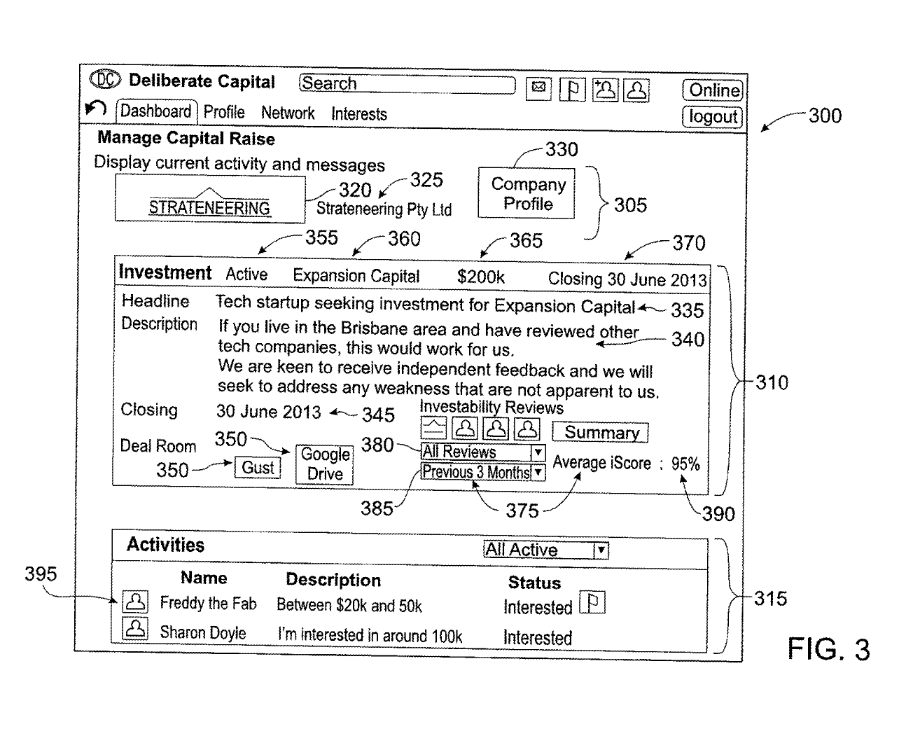

FIG. 3 illustrates a screenshot 300 of a manage capital page of the system 100, according to an embodiment of the present invention. The manage capital page enables a user to view activity associated with a request for capital, as well as view messages from other users regarding the request for capital.

The manage capital page includes a company details portion 305, for providing details of the company to which the request for capital pertains, an investment portion 310, providing details of the request for capital, and an activities portion 315, providing details of activities, such as communications, associated with the request for capital.

The company details portion 305 includes a company image 320, a company identifier 325 and a company profile button 330. The company identifier 325 can, for example, be a company name, a trading name, or any other suitable identifier of the company. The company profile button 330 provides a link to a company profile page.

The investment portion 310 includes a headline component 335, and a description component 340, for providing a headline and a detailed description of the request for capital. The investment portion 310 further includes a closing date identifier 345, identifying when the request for capital closes, and deal room buttons 350, for providing links to deal rooms, where further discussions and sharing of documents can take place. Examples of relevant deal rooms include Gust, by Gust, LLC of New York, United States, and Google Drive, by Google Inc. of Mountain View, Calif., United States.

The investment portion 310 further includes an active indicator flag 355, indicating if the request for capital is active, a category field 360, indicating a category of the request for capital, a value field 365, indicating a value of the request for capital, and closing field 370, indicating identifying when the request for capital closes

Finally, the investment portion 310 further includes a review portion 375, for providing reviews associated with the company and/or the request for capital. The review portion 375 includes a reviewer selection drop down menu 380, for selecting a subset of reviewers for which to provide a review, and a time selection drop down menu 385, for selecting a time frame within which a subset of reviews are selected.

Upon selection of a subset of reviewers and/or a time frame using the reviewer selection drop down menu 380 and/or the time selection drop down menu 385, a score element 390 is updated to consider the subset of reviewers and/or the time frame.

The score element 390 provides the user with a quick overview of the company, as viewed by other investors, such as investors in a network with the user, in the form of a score. The score advantageously comprises a number, such as a percentage or a rating out of 5 or 10, to easily enable the user to compare scores.

The score is derived by combining ratings of several users. According to certain embodiments, the ratings of the several users are each weighted based upon an association between the users by which the weighting is provided, an age of the reviews, and a preference of a user. The association between two users can, for example, comprise a connection in an external social networking system, or a connection or association in the system 100.

As discussed further below, the ratings can each comprise a plurality of ratings with respect to different aspects of the company, including a rating with respect to a market of the company, a rating with respect to a business model, and/or ratings with respect to other factors such as team, traction, monetization, competition, company health and profile.

For example, the score can be weighted based upon an importance of each of the aspects of the company, according to the preference of the user. If an investor considers the market of the company to be a very important element, it can be given a higher weighting than other features of the company. Additionally, scores can be weighted based upon other factors such as age.

The activities portion 315 provides details of activities that are associated with the request for capital in the form of a plurality of activity entries 395. The activity entries 395 comprise activities of other users, such as communications from the other users. Upon selection of an activity entry 395, details of the corresponding activity are presented.

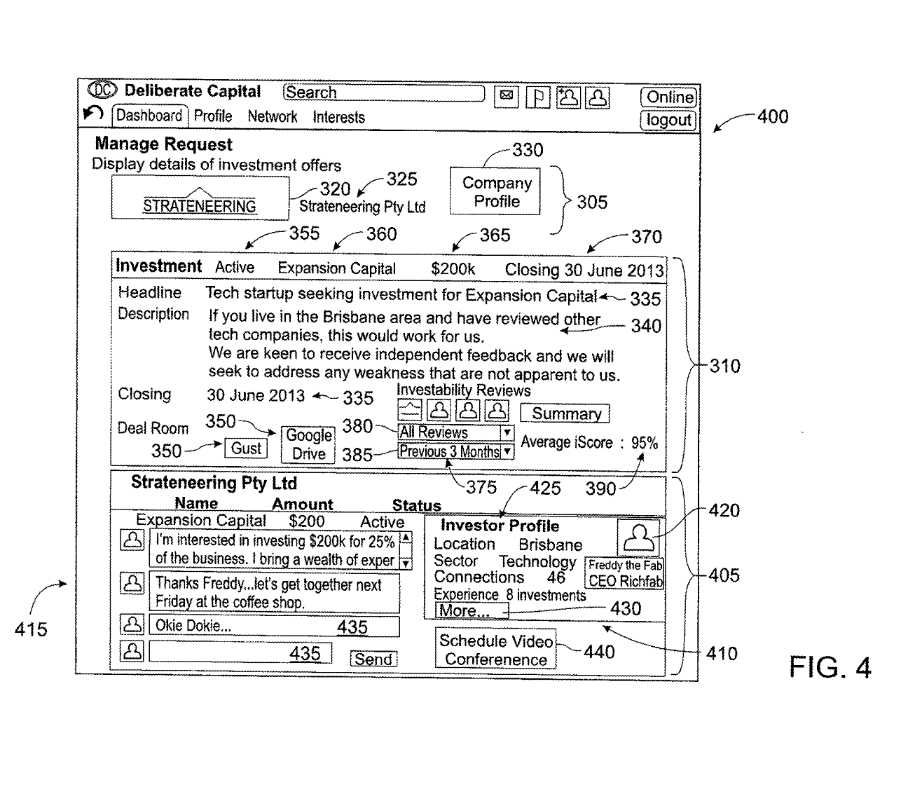

FIG. 4 illustrates a further screenshot 400 of the manage capital page, according to an embodiment of the present invention. Details of an activity, in the form of a communication from an investor, are provided.

The manage capital page includes an activity details section 405, including an investor profile section 410 and a communications section 415.

The investor profile section 410 includes details of the potential investor from which the activity originates, including an image 420, investor details 425 such as a location, a sector, a number of connections and experience of the investor, and a more button 430, providing a link to further details of the investor, such as a full profile.

The communications section 415 includes a plurality of text boxes 435, for communicating between the user and the investor. The plurality of text boxes 435 provide a chat-like function where messages can be sent back and forth between the user and investor, and viewed at a later point in time.

Finally, the manage capital page includes a schedule video conference button 440, which can be selected by the user to schedule a video conference with the investor. Upon selection of the schedule video conference button 440 a video conferencing booking system can be provided, thus enabling the user to schedule a video conference.

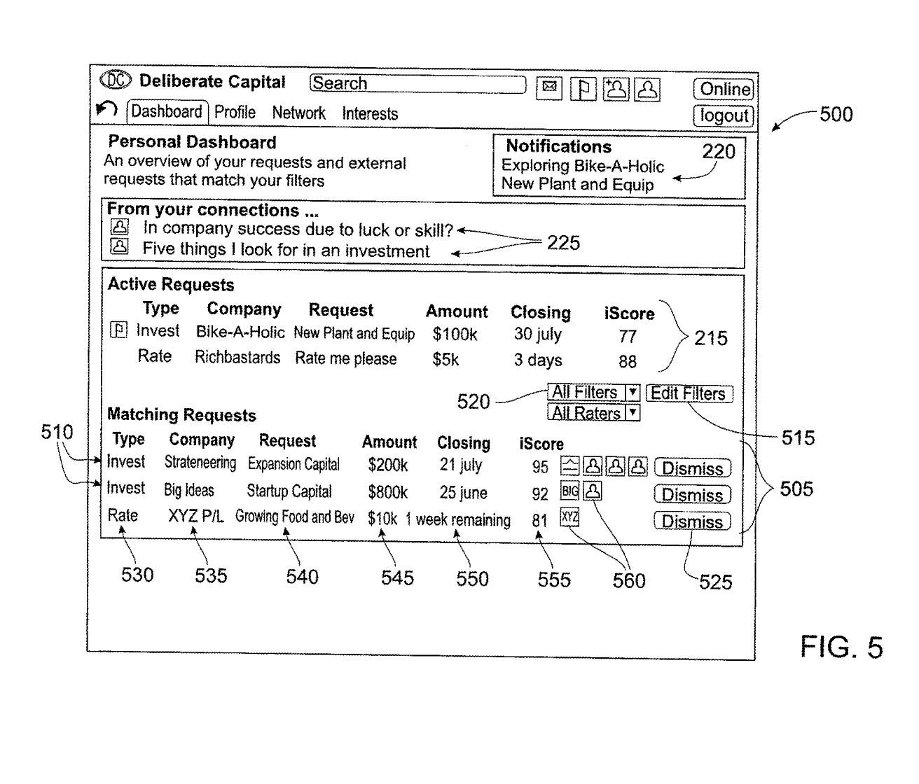

FIG. 5 illustrates a screenshot 500 of a further personal dashboard page of the system 100, according to an embodiment of the present invention. The further personal dashboard page is similar to the personal dashboard page of FIG. 2, but for another user.

The further personal dashboard page includes a matching requests portion 505, similar to the active requests portion 215 of FIG. 2, and including a plurality of request for investment elements 510. Each of the request for investment elements 510 is associated with a request for investment, such as a request for capital, from another user.

According to certain embodiments, a user can set up a filter, to define which requests for capital are provided as the request for investment elements 510 in the matching requests portion 505. The filter can require, for example, a minimum or maximum score, either overall or for individual categories of a company, or limit requests to particular categories of technology.

Filters can be generated using an edit filters button 515, and existing filters can be selected using a filter selection menu 520. By filtering the investment requests, a user can ensure that only relevant requests for investment are presented, providing a more efficient selection among investment opportunities.

The request for investment elements 510 can each be selected by the user to be placed in the active requests portion 215, or dismissed using a dismiss request button 525 such that the request for investment element 510 is no longer shown to the user.

This enables a user to efficiently manage requests for capital, as request for investment elements 510 can be dismissed with a single click, or selected as an active request if further review or investment is anticipated. According to certain embodiments, certain functionality, such as communication functionality, are provided for request for capital elements 510 that have been moved to the active requests portion 215, but not those remaining in the matching requests portion 505.

Each investment request element 510 includes a type field 530, indicating a type of the request, such as an investment request or a rating request, a company identifier field 535, comprising an identifier of the company such as a name, and a request details identifier 540, indicating details of the request, such as whether the request is for start-up capital or expansion capital.

Each investment request element 510 further includes an amount identifier 545, indicating an amount associated with the request, a closing identifier 550, indicating when the request closes, and score field 555 and a plurality of reviewer identifiers 560.

The score field 555 comprises a score, similar to the score element 390. The score is derived by combining ratings of several users, each user identified by a reviewer identifier 560, which can be in the form of an image or icon. Similarly, the score can be generated according to preferences of the user, such as an importance of different aspects of the company, or according to a relationship between the user and the reviewers. In such case, trusted reviewers are given more weight when generating the score than reviewers that are not trusted.

According to certain embodiments, degrees of trust are determined or provided between users. In particular, a user that is trusted by a large number of users can be given a higher degree of trust than a user that is only trusted by a single user. Alternatively or additionally, a user can manually select or override a degree of trust associated with a user.

According to certain embodiments, an individual score (not shown) is associated with each reviewer identifier 560, enabling the user to get an overview of what each reviewer has provided as a score. This enables users to quickly identify reviewers and reviews that deviate from the norm.

Upon selection of a request, a manage request page is provided.

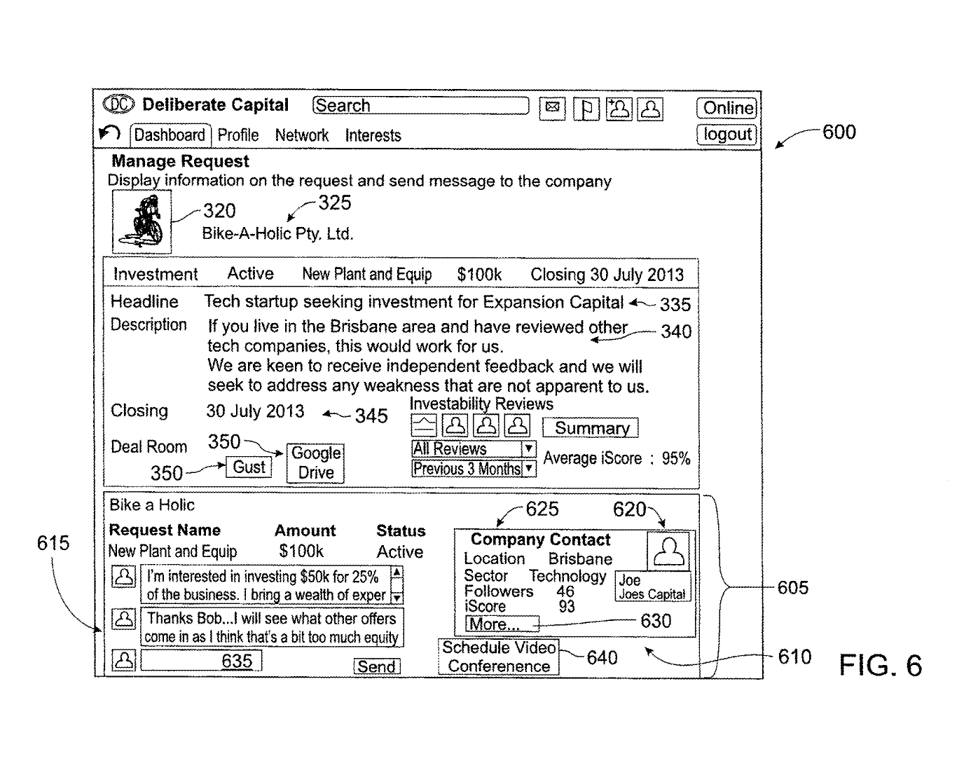

FIG. 6 illustrates a screenshot 600 of a manage request page of the system 100, according to an embodiment of the present invention.

The manage request page includes a communications section 605, which is similar to the activity details section 405 of FIG. 4 in the case of a communication activity. The communications section 605 includes a company contact section 610 and a messaging section 615.

The company contact section 610 includes details of a contact of the company, including an image 620 of the contact, contact details 625 such as location, sector, number of connections, followers and a score, and a more button 630, providing a link to further details of the company contact, such as a full profile.

As will be readily understood by a skilled addressee, the company contact section can include a profile of a person associated with the company, and/or the company itself

The messaging section 615 includes a plurality of text boxes 635, for communicating between the user and the company contact. The plurality of text boxes 635 provide a chat-like function where messages can be sent back and forth between users, and viewed at a later point in time.

This enables the user to ask questions about the company, discuss initial investment proposals, or otherwise communicate with a representative of the company

Finally, the manage capital page includes a schedule video conference button 640, which can be selected by the user to schedule a video conference with the company contact.

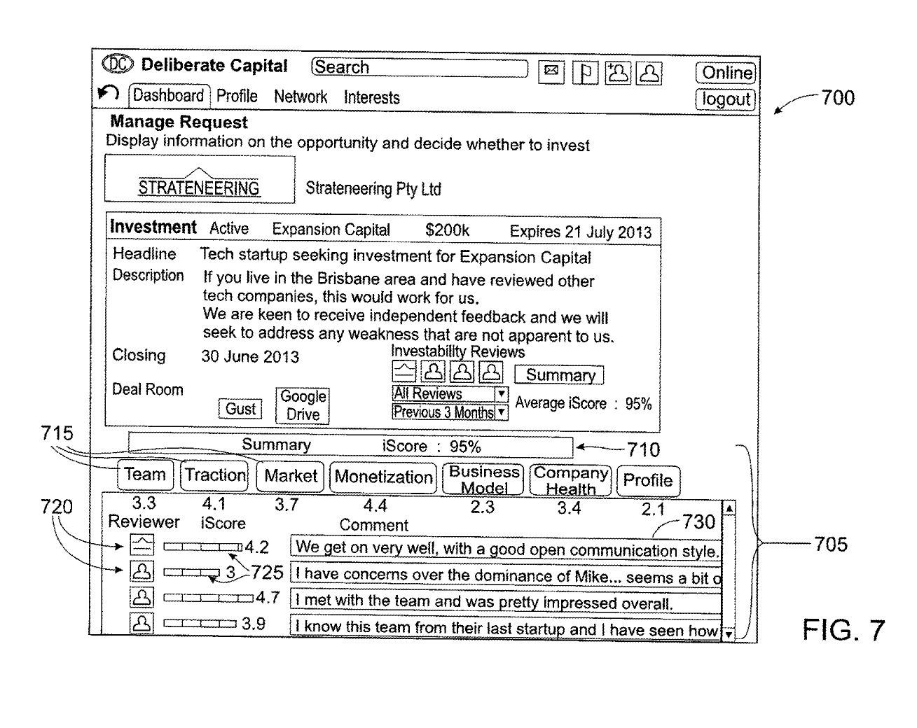

FIG. 7 illustrates a screenshot 700 of a further manage request page of the system 100, including investability review details, according to an embodiment of the present invention.

The further manage request page includes an investability review portion 705 including a summary component 710, a plurality of category tabs 715 and a plurality of review elements 720. The summary component 710 includes an overall score element, the score element comprising a number indicating a level of investability as seen by users of the system, e.g. investors.

The plurality of category tabs 715 includes a team tab, a traction tab, a market tab, a monetization tab, a competition tab, and business model tab, a company health tab, and a profile tab. Associated with each of the plurality of category tabs 715 is a category score, illustrating a score associated with the respective category. This enables a potential investor to get a quick overview of the strengths and weaknesses of the company, as perceived by other users/investors, and with respect to a particular category.

Each review element 720 is associated with a reviewer, e.g. another investor, and includes a score element 725 and a comment element 730. The score element 725 is similar to the overall score element of the summary component 710, but for an individual reviewer. The comment element 730 comprises a free-text field, where the reviewer is able to provide a textual summary or justification of the review.

According to certain embodiments, the plurality of category tabs 715 are selectable by the user. Upon selection of a category tab 715, the review elements 720 are updated according to the selected category. In particular, the score elements 725 are updated to indicate a score for the particular category, and the comment element 730 is updated to provide comments with regard to the category.

This enables a potential investor to quickly obtain information regarding the company, from several sources, and customised with regard to particular aspects of the company the investor finds important.

As will be readily understood by the skilled addressee, the score elements 725, and/or other scores and ratings discussed herein, can be present in a variety of ways, including by colour coding, categorization (e.g. “good”, “poor”), numerically (e.g. a percentage, or a rating out of 5 or 10), or a combination thereof.

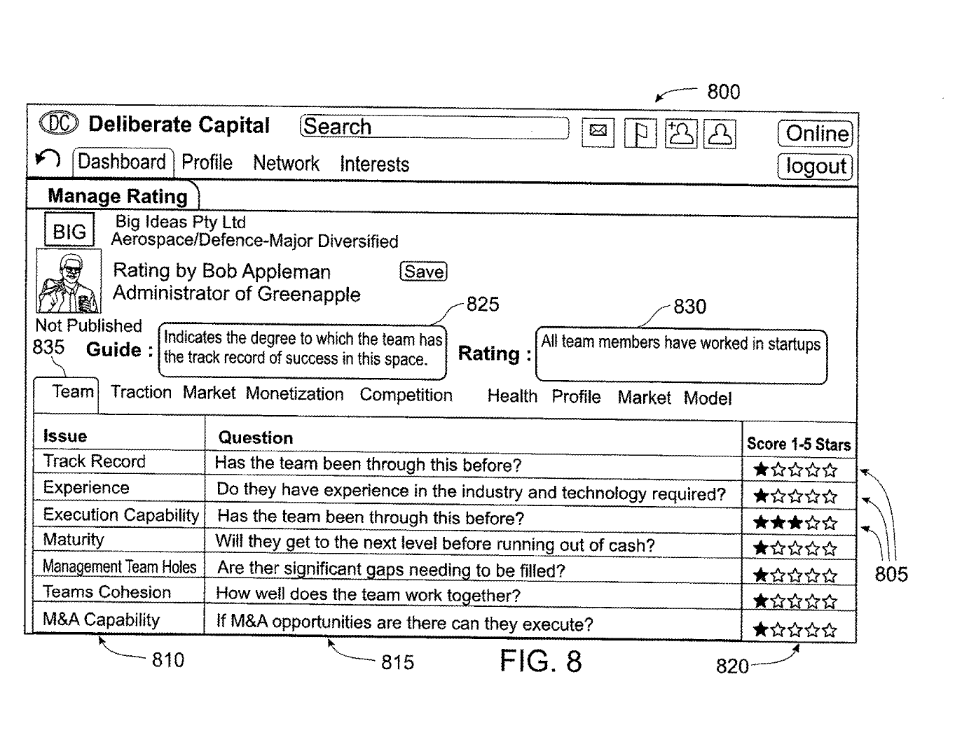

FIG. 8 illustrates a screenshot 800 of a manage rating page of the system 100, according to an embodiment of the present invention.

The manage rating page enables users to provide a rating of a company, as discussed above, by answering a plurality of questions.

The manage rating page includes a plurality of rating elements 805, wherein each rating element 805 comprises an issue element 810, a question element 815 and a score element 820. The issue element 810 provides a brief description of an issue surrounding the rating element, such as a track record or experience of the company, to assist the user in interpreting the relevance and importance of the rating element.

The question element 815 provides a question to the user, which an answer is to be provided in the score element 820. The score element 820 advantageously comprises a plurality of stars, enabling the user to enter a star rating, e.g. a star rating between 1 and 5 stars, for indicating a response to the question element 815.

The manage rating page further includes a question guide element 825 and a rating guide element 830, which are dynamically updated according to a rating element 805 that is selected. The question guide element 825 provides further details as to what a user should consider with respect to a rating element 805 that is active, and the rating guide element 830 provides further details as to how a rating of the score element 820 is to be interpreted.

In particular, as a user moves a pointer, or other input device, over a particular component (e.g. star) of a score element 820, the rating guide element 830 is updated to give an indication of how the particular component of the score element 820 is to be interpreted. The rating guide element 830 can quantify the score element, or provide guidelines on how the score element is to be interpreted.

As an illustrative example, a question element 815 may relate to whether team members of a company have previously worked in a start-up company. A star rating of five stars in the score element 820 can correspond to that all team members have worked in a start-up company before, and accordingly, a message indicating this can be provided in the rating guide element 830 when a user selects a five star rating in the score element 820, or places a cursor over the five star rating of the score element 820.

According to certain embodiments, all rating elements default to a particular value. In such case, the value can correspond to a low value, an unknown value, or average value. In particular, all rating elements can default to a lowest rating value, such as a single star rating.

According to some embodiments (not shown), the manage rating page further includes a confidence element. The confidence element enables a user to select a confidence to be associated with a score, such as the user is very confident with their score. The confidence element can also comprise a star rating, for example out of 5, similar to the score element 820, indicating how confident the user is with their rating.

The manage rating page further includes a plurality of category tabs 835, for selecting a category of questions. In particular, the rating elements 805 are organised according to categories, and each of the categories is selectable by a category tab 835. Examples of categories include a team category, a traction category, and a market category.

As discussed above, a user can set up a filter for filtering investment requests from other users. In such case, generating a filter can be performed in a similar manner to providing a rating, as discussed with reference to FIG. 8. In this case, instead of rating a company, the filter comprises a minimum rating, for a plurality of criteria, which a company must fulfill to be provided to the user as a matching request.

The system 100 can then compare the minimum ratings provided in the filter with ratings of companies (as provided by other users), and select a subset of investment requests to display to the user.

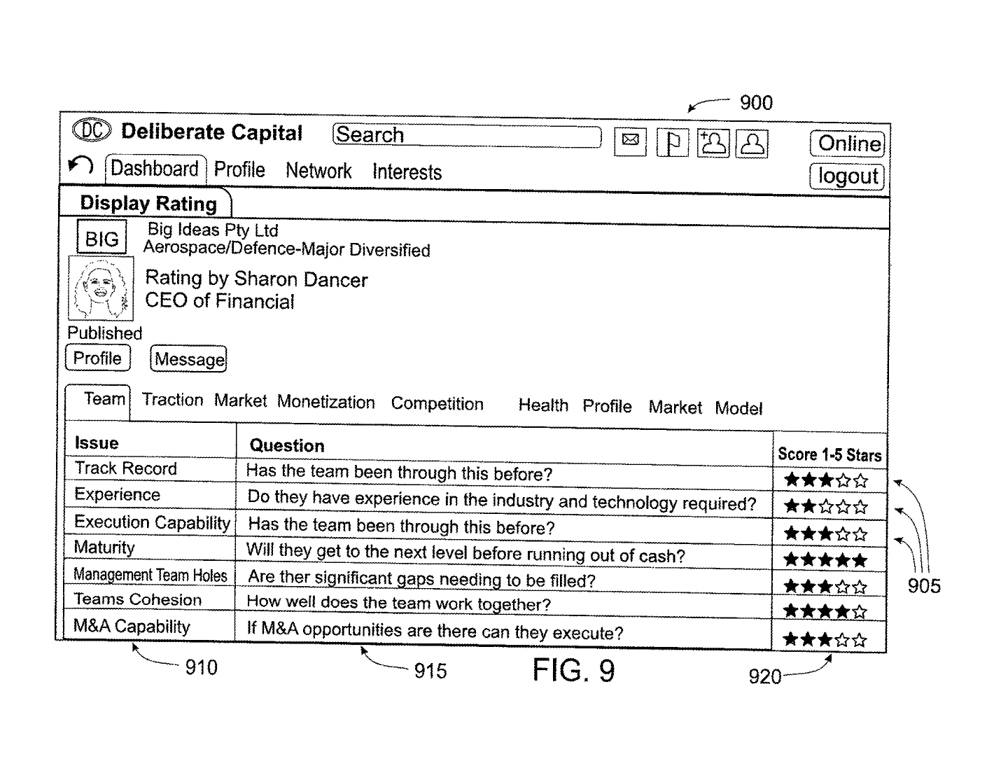

FIG. 9 illustrates a screenshot 900 of a display rating page of the system 100, according to an embodiment of the present invention. The display rating page includes a plurality of rating elements 905, similar to the rating elements 805 of FIG. 8. The rating elements 905 comprise an issue element 910, a question element 915 and a score element 920. The issue element 910, the question element 915 and the score element 920 are similar to the issue element 810, the question element 815 and the score element 820 of FIG. 8, but for the purpose of displaying a rating rather than entering a rating.

The display rating page enables a user to get an overview of the rating of the company, as perceived by other users, which can be a useful tool in determining which aspects of the company are considered strong, and which aspects may need improvement.

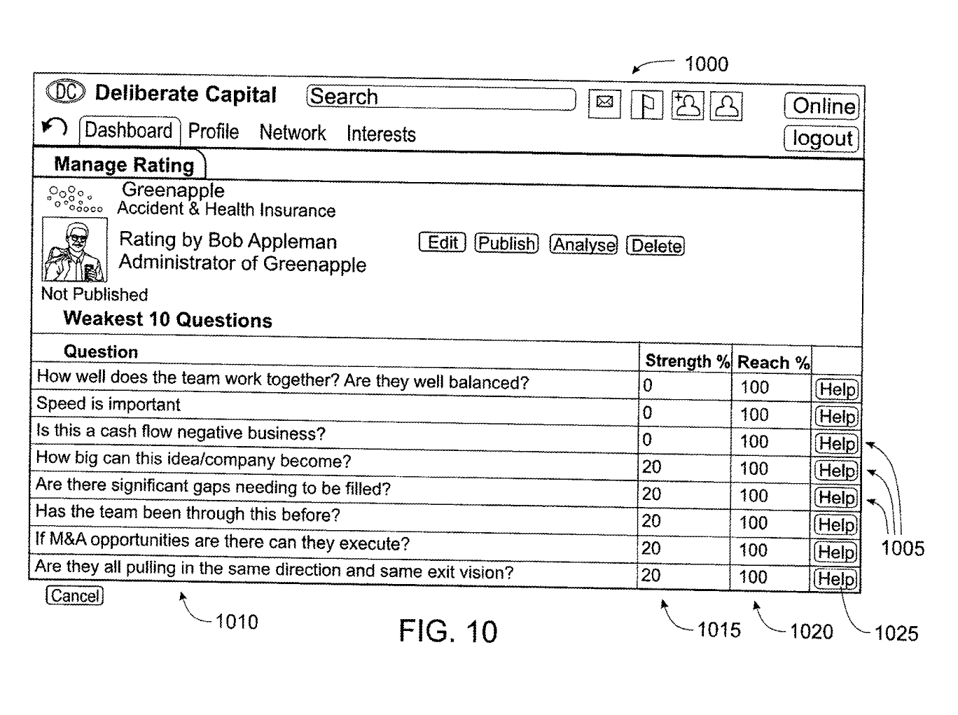

FIG. 10 illustrates a screenshot 1000 of a rating analysis page of the system 100, according to an embodiment of the present invention.

The rating analysis page provides an analysis of the ratings provided by other users, and in particular with reference to the areas which are considered to affect investability. The rating analysis includes an analysis of the “weakest” 10 questions, which illustrate the areas in which a company is perceived to be poor, and enables a company to improve their investability by addressing these questions.

In particular, the rating analysis page includes a plurality of question elements 1005, wherein each question element includes a question statement section 1010, a strength field 1015, a reach field 1020 and a help button 1025.

The question statement section 1010 includes a question, or portion thereof, which corresponds to a question element 815 of FIG. 8. The strength field 1015 indicates how the company is perceived with respect to the question element 1005, and is advantageously presented as a percentage. In such case, a low strength indicates that the company is not perceived to be particularly strong in the particular area.

The reach field 1020 indicates how many potential investors are shown the request for capital based on the question. In particular, a reach of 100% indicates that no potential investors have a filter that would block a request for investment based upon this question, and a low reach indicates that a large number of potentials investors have a filter that would block a request for investment based upon this question.

Accordingly, a user can identify the questions which are most likely to prevent a request for investment from reaching an investor, and can thus address these aspects of the firm. For example, if staff of the company have no experience in a particular area, and this would prevent investors from receiving a request for investment, the company may choose to expand their experience in this area.

Finally, the help button 1025 can be used by the user to obtain help regarding a particular question. In particular, the system 100 includes a plurality of articles, wherein each of the articles can be associated with a questions (as discussed further below). Upon selection of the help button, one or more relevant articles are selected for presentation to the user. The articles can provide advice on how to improve investability in the company based upon the particular question.

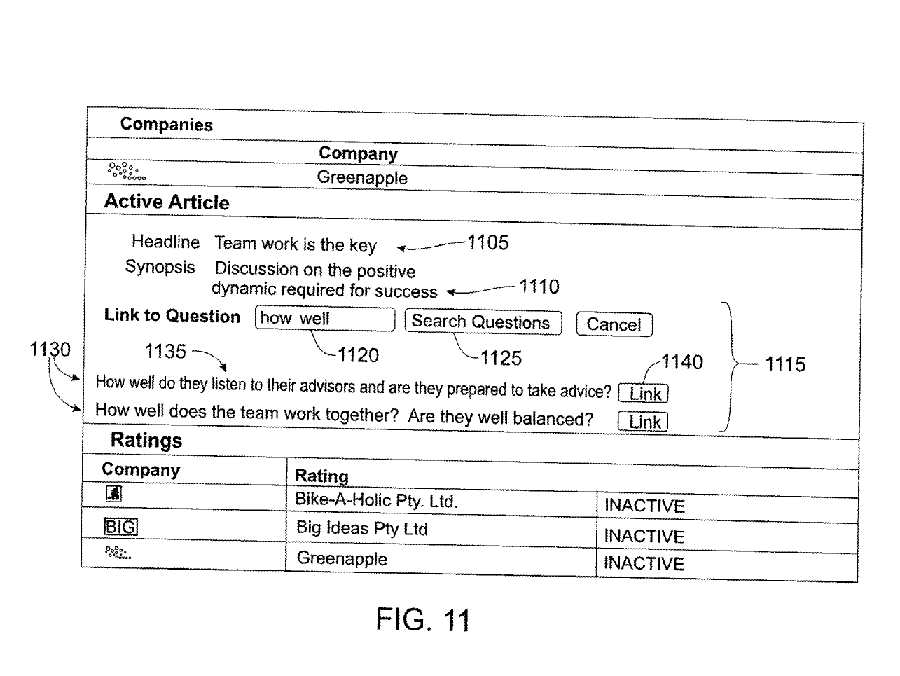

FIG. 11 illustrates a screenshot 1100 of an activate article page of the system 100, according to an embodiment of the present invention. As discussed above, a user can post an article to the system 100, which can then be accessed by other users wishing to address a point on which their company is considered weak.

In particular, the article is first added to the system, for example by being uploaded, or drafted directly in the system 100. The article can then be activated using the activate article page.

The activate article page includes a headline element 1105, indicating a headline of the article, a synopsis element 1110, indicating a synopsis of the article, and a link to question section 1115, for enabling the user to link the article to one or more questions.

The link to question section 1115 includes a search questions input field 1120 and a search button 1125, which enables the user to search for questions based upon a keyword or other suitable identifier. The link to question section further includes a plurality of identified question elements 1130, each identified question element 1130 corresponding to a question identified using the search questions input field 1120.

Each identified question element 1130 includes a question statement 1135 and a link button 1140. The question statement 1130 provides a summary of the question, and the link button 1140 can be selected to provide a link between the article and the corresponding question.

Users which then require help with the question are then able to read the article to receive help with respect to the question.

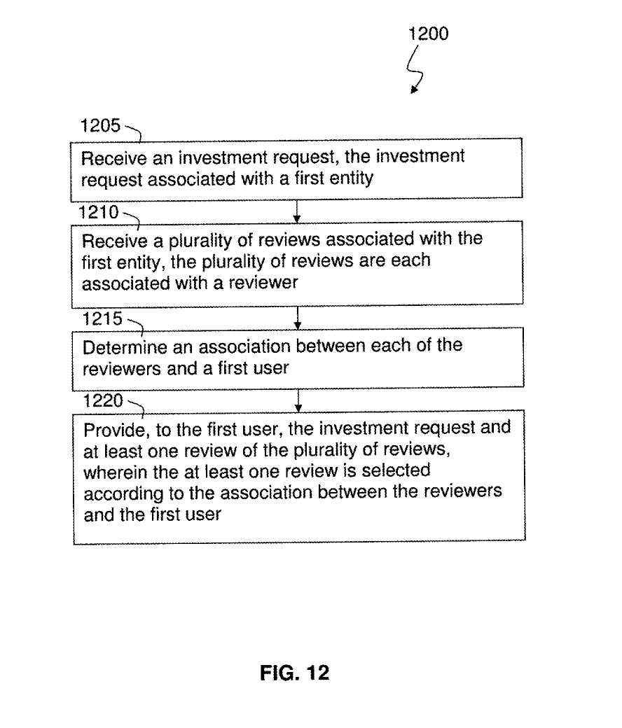

FIG. 12 illustrates a method 1200 of communication, according to an embodiment of the present invention.

At step 1205, a request for investment is received on a data interface. The request for investment is associated with a first entity, e.g. a company. The request for investment can, for example, comprise a request for capital.

At step 1210, a plurality of reviews associated with the first entity are received on the data interface, wherein the plurality of reviews are each associated with a reviewer. The reviewers are typically investors that are aware of the first entity, and are able to provide an opinion about the strengths and/or weaknesses of the first entity.

The review can comprise a score and/or a textual element (e.g. a written opinion).

According to certain embodiments, each review of the plurality of reviews include a plurality of review components, wherein each review component is associated with a category.

Preferably, the categories include at least one of: a team category, a traction category, a market category, a monetization category, a competition category, a business model category, a company health category and a profile category.

At step 1215, an association between each of the reviewers and a first user is determined by a processor. The reviewers and the first user can, for example, be in a common network of users, or the reviewer can be trusted by the first user.

At step 1220, the request for capital is provided on the data interface together with at least one review of the plurality of reviews. The at least one review is selected according to the association between each of the reviewers and a first user.

As an illustrative example, all reviews by trusted reviewers of the first user can be provided on the data interface. As a further example, reviews can be weighted according to the association between the corresponding reviewer and the first user, for example whether the reviewer is trusted by the first user.

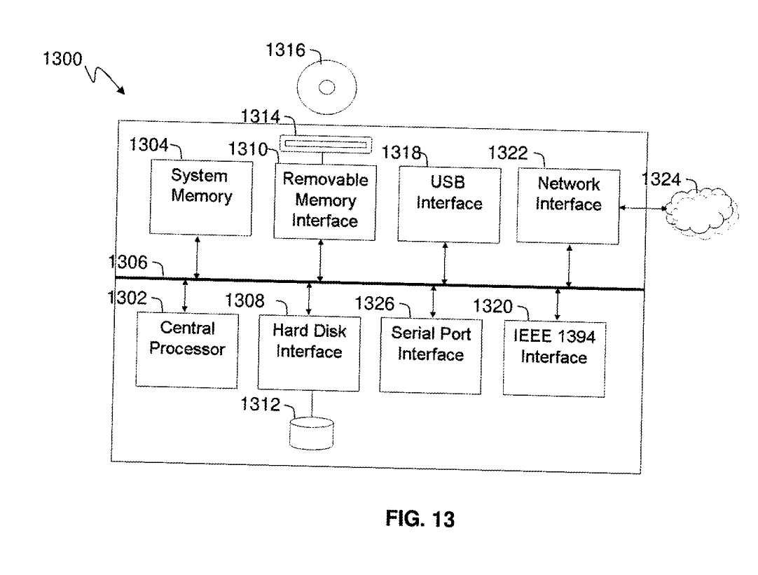

FIG. 13 diagrammatically illustrates a computing device 1300, according to an embodiment of the present invention. The system 100 and/or the method 1200 can be implemented using the computing device 1300.

The computing device 1300 includes a central processor 1302, a system memory 1304 and a system bus 1306 that couples various system components, including coupling the system memory 1304 to the central processor 1302. The system bus 1306 may be any of several types of bus structures including a memory bus or memory controller, a peripheral bus, and a local bus using any of a variety of bus architectures. The structure of system memory 1304 is well known to those skilled in the art and may include a basic input/output system (BIOS) stored in a read only memory (ROM) and one or more program modules such as operating systems, application programs and program data stored in random access memory (RAM).

The computing device 1300 can also include a variety of interface units and drives for reading and writing data. The data can include, for example, asset and user profiles as discussed above.

In particular, the computing device 1300 includes a hard disk interface 1308 and a removable memory interface 1310, respectively coupling a hard disk drive 1312 and a removable memory drive 1314 to the system bus 1306. Examples of removable memory drives 1314 include magnetic disk drives and optical disk drives. The drives and their associated computer-readable media, such as a Digital Versatile Disc (DVD) 1316 provide non-volatile storage of computer readable instructions, data structures, program modules and other data for the computer system 1300. A single hard disk drive 1312 and a single removable memory drive 1314 are shown for illustration purposes only and with the understanding that the computing device 1300 can include several similar drives. Furthermore, the computing device 1300 can include drives for interfacing with other types of computer readable media.

The computing device 1300 may include additional interfaces for connecting devices to the system bus 1306. FIG. 13 shows a universal serial bus (USB) interface 1318 which may be used to couple a device to the system bus 1306. For example, an IEEE 1394 interface 1320 may be used to couple additional devices to the computing device 1300. Examples of additional devices include cameras for receiving images or video, or microphones for recording audio.

The computing device 1300 can operate in a networked environment using logical connections to one or more remote computers or other devices, such as a server, a router, a network personal computer, a peer device or other common network node, a wireless telephone or wireless personal digital assistant. The computing device 1300 includes a network interface 1322 that couples the system bus 1306 to a local area network (LAN) 1324. Networking environments are commonplace in offices, enterprise-wide computer networks and home computer systems.

A wide area network (WAN), such as the Internet, can also be accessed by the computing device, for example via a modem unit connected to a serial port interface 1326 or via the LAN 1324.

Transmission of data can be performed using the LAN 1324, the WAN, or a combination thereof

It will be appreciated that the network connections shown and described are exemplary and other ways of establishing a communications link between computers can be used. The existence of any of various well-known protocols, such as TCP/IP, Frame Relay, Ethernet, FTP, HTTP and the like, is presumed, and the computing device 1300 can be operated in a client-server configuration to permit a user to retrieve data from, for example, a web-based server.

The operation of the computing device 1300 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCs, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

In summary, advantages of certain embodiments of the present invention include an ability to efficiently pair investors and start-up companies, which can provide higher levels of investment and lower levels of risk associated with an investment.

Furthermore, certain embodiments of the present invention enable efficient transfer of knowledge between investors in a network, which facilitates efficient evaluation of investment proposals by the investors.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A method of communication, comprising:
receiving, on a data interface, an investment request, wherein the investment request is associated with a first entity;
receiving, on the data interface, a plurality of reviews associated with the first entity, wherein the plurality of reviews are each associated with a reviewer;
determining, by a processor, an association between the reviewers and a first user; and
providing, on the data interface and to the first user, the investment request and at least one review of the plurality of reviews, wherein the at least one review is selected according to the association between the reviewers and the first user.

2. The method of communication of claim 1, wherein the first entity is a company and the investment request comprises a request for capital.

3. The method of communication of claim 1, wherein each review in the plurality of reviews comprises a score.

4. The method of communication of claim 1, wherein each review in the plurality of reviews comprises a textual element.

5. The method of communication of claim 1, wherein providing the at least one review comprises providing a weighted score of a plurality of reviews.

6. The method of communication of claim 5, wherein the weighted score is determined according to an association between the respective reviewers and the first user, and an age of the reviews.

7. The method of communication of claim 1, the method further comprising:
receiving, on the data interface, a preference from the first user;
wherein the weighted score is further determined according to the preference.

8. The method of communication of claim 1, wherein the association comprises at least one of the following: a relationship in a social network; a trust-based association; and a trust-based association comprises a level of trust.

9. The method of communication of claim 1, wherein each review in the plurality of reviews includes a plurality of review components, wherein each review component is associated with a category.

10. The method of communication of claim 9, wherein the category includes at least one of the following: a team category, a traction category, a market category, a monetization category, a competition category, a business model category, a company health category and a profile category.

11. The method of communication of claim 1, the method further comprising:
providing, on the data interface, a user customisable dashboard, the user customisable dashboard including the investment request and the at least one review.

12. The method of communication of claim 1, the method further comprising:
receiving, on the data interface, a plurality of investment requests, each of the investment requests associated with an entity; wherein the user customisable dashboard further includes at least one of the plurality of investment requests.

13. The method of communication of claim 1, the method further comprising:
receiving, on the data interface, at least one filter parameter associated with the first user;
wherein at least one request of the plurality of investment requests is selected according to the filter.

14. The method of communication of claim 13, wherein the at least one filter parameter comprises at least one of a minimum rating, a minimum trusted rating, a minimum category rating, a location and a technology area.

15. A communications system, comprising:
a data interface;
a processor coupled to the data interface; and
a memory coupled to the processor, the memory including instruction code executable by the processor for:
receiving, on the data interface, an investment request, wherein the investment request is associated with a first entity;
receiving, on the data interface, a plurality of reviews associated with the first entity, wherein the plurality of reviews are each associated with a reviewer;
determining an association between each of the reviewers and a first user; and
providing, on the data interface and to the first user, the investment request and at least one review of the plurality of reviews, wherein the at least one review is selected according to the association between the reviewers and a first user.

16. A computer implemented investment system, comprising:
a memory including:
a plurality of user profiles, each of the plurality of user profiles associated with a user;
a plurality of company profiles, each of the plurality of company profiles associated with a company;
a plurality of investment requests, wherein each investment request is associated with a company; and
a plurality of reviews; wherein each review is associated with a user profile and a company profile;
a linking module, for providing an association between user profiles, and between user profiles and company profiles; and
a dashboard module, for providing investment requests and reviews to users, wherein the reviews are provided according to an association between a user profile and other user profiles to which the reviews are associated.
